(19) United States
(12) Patent Application Publication
(10) Pub. No.: US 2019/0180993 A1
(43) Pub. Date: Jun. 13, 2019

(54) SYSTEM FOR PERFORMING MANUAL SEGMENTATION OF MASS SPECTROMETRY DATA

(71) Applicant: University of Montana, Missoula, MT (US)

(72) Inventor: Robert Smith, Greenough, MT (US)

(21) Appl. No.: 15/834,548

(22) Filed: Dec. 7, 2017

(51) Int. Cl. H01J 49/00

(52) U.S. Cl. CPC H01J 49/0036

(57) ABSTRACT

Systems and methods for identifying isotopic traces and isotopic envelopes from mass spectrometry data where identification is based on probabilities derived from the data. The probabilities allow the best and most likely assignment of isotopic trace points to isotopic traces and assignment of the most likely isotopic traces to isotopic envelopes. The resulting isotopic traces and isotopic envelopes are displayed graphically to the user who can provide segmentation input assigning, deleting, or combining isotopic trace points to isotopic traces, isotopic traces to isotopic envelopes, or both. Once the user has provided segmentation input, the systems and methods recalculate probabilities for isotopic trace points, isotopic traces, and isotopic envelopes and update the segmented mass spectrometry data.

### STATEMENT REGARDING FEDERALLY SPONSORED RESEARCH

This invention was made with government support under federal grant number 1552240 from the NSF. The U.S. Government has certain rights to this invention.

### FIELD OF THE INVENTION

Embodiments described herein relate to a system that performs segmentation of mass spectrometry data to improve the accuracy of data analysis.

### SUMMARY OF THE INVENTION

The mass spectrometry segmentation system described herein assigns isotopic trace points to isotopic traces and assigns isotopic traces to isotopic envelopes using a probabilistic method. The system also accepts input from a user that manually segments mass spectrometry data presented to the user, updates assignment of isotopic trace points to isotopic traces and isotopic traces to isotopic envelopes, and stores the segmented data for further segmentation by a user or use in scientific analysis.

BACKGROUND

Mass spectrometry nomenclature may be ambiguous. For the purposes of this document, the following definitions will be used. First, isotopic trace refers accumulated signal of instances of a given molecule at a given charge state whose molecular formula contains the same isotopic composition, either in profile or centroided form. Second, isotopic envelope refers to the accumulated signal instances of a given molecule at a given charge state, including molecules with differing isotopic composition, either in profile or centroided form. Manual segmentation shall refer to the delineation of bounds of at least one isotopic trace or isotopic envelope by a human; that is, the isotopic trace point membership assessed by a human of as to being included in specific isotopic traces and which isotopic traces should be included in which isotopic envelopes for every usable point in a mass spectrometry run. Manual segmentation provides a means to collect all useable signals in a visualization of mass spectrometry data without the poor performance of automated computational segmentation. Manual segmentation without specialized software is possible but in most cases is done crudely using, for example, spreadsheet software. Some software allows three dimensional (3-D) viewing of mass spectrometry data, but does not allow a user to delineate signal bounds, accumulate signals into isotopic traces, accumulate isotopic traces into isotopic envelopes, or save said delineations or accumulations.

Mass spectrometry is a means of ascertaining the composition of a molecular sample. Existing means for generating a list of molecule types and quantities in a sample include the use of secondary or tandem mass spectrometry, also known as MS/MS coupled with data from the primary or MS1 mass spectrometry experimental component. The pairing of MS/MS information with MS1 information and the extraction of MS1 information are computational processes. MS1 information extraction provides the potential to accurately identify and quantify a greater portion of molecules in a sample by providing more discriminatory information and more accurate abundance measures than MS/MS means alone.

Automated computational means of extracting some isotopic traces or portions of isotopic envelopes from a file have been published. These methods do not capture the majority of signals in a sample, and have limited quantitative accuracy on the signals they do capture. One reason these methods perform so poorly is that the signal structure in a mass spectrometry file varies greatly, and algorithms that segment one type of signal well will typically segment other types of signal poorly. Manual segmentation—the delineation of bounds of at least one isotopic trace or isotopic envelope by a human—is a technique for which no software has been publicly released to date.

Manual segmentation provides a means to segment all useable signals in a mass spectrometry output without the poor performance of automated computational segmentation. Manual segmentation without specialized software is not possible in any but the crudest sense. Some software allows 3-d viewing of mass spectrometry data, but none allow a user to delineate signal bounds or save said delineations.

A method for segmenting mass spectrometry data is described herein, the method comprises retrieving, with an electronic processor, a plurality of isotopic trace points stored as mass spectrometry data in an electronic repository. The method includes identifying a plurality of isotopic traces, wherein of the plurality of isotopic traces comprises a subset of the plurality of isotopic trace points retrieved from the mass spectrometry data. The isotopic traces are identified as belonging to one of a plurality of isotopic envelopes. The method stores isotopic traces and isotopic envelopes identified as segmentation data, presenting, on an output device, the plurality of isotopic traces and isotopic envelopes to a user. The method accepts input from an input device segmenting the graphic display of mass spectrometry data, updating the mass spectrometry data and the segmentation data using the input segmenting the mass spectrometry data, and presenting, on the output device, an updated graphic display of the mass spectrometry data based on the user supplied input segmenting the mass spectrometry data.

### BRIEF DESCRIPTION OF THE DRAWINGS

FIG. 1 illustrates an example embodiment of the Manual Segmentation System.

FIG. 2 illustrates an example method for segmenting isotopic envelopes presented to a user on an output device.

FIG. 3 shows an example method for assigning isotopic points to isotopic traces and isotopic envelopes.

FIG. 4 shows an example method for assigning isotopic traces to isotopic envelopes.

### DETAILED DESCRIPTION

One or more embodiments are described and illustrated in the following description and accompanying drawings.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. Moreover, relational terms such as first and second, top and bottom, and the like may be used herein solely to distinguish one entity or action from another entity or action without necessarily requiring or implying any actual such relationship or order between such entities or actions.

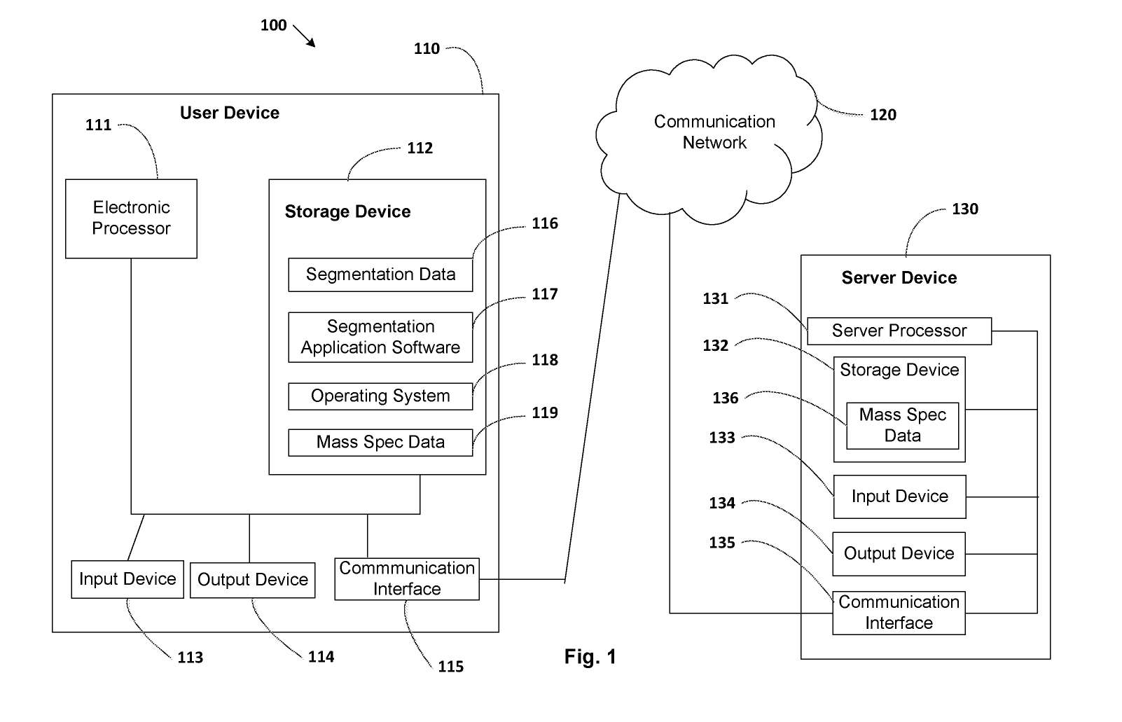

FIG. 1 illustrates a block diagram of a system 100 for identifying and presenting isotopic traces and isotopic envelopes, and manually segmenting mass spectrometry data according to one embodiment. In the example embodiment shown in FIG. 1, the system 100 includes a user device 110, a communication network 120, and a server device 130. The communication network 120 may be a wired or wireless communication network. Portions of the communication network 120 may be implemented using a wide area network, (for example, the Intranet), a local area network (for example, a Bluetooth™ network or Wi-Fi network), and combinations or derivatives thereof

The user device 120 may be a laptop or desktop computer or a server, although other devices, including a tablet computer or other portable computing device could also be utilized. The administrator device 110 includes an electronic processor 111, a memory or a similar storage device 112, an input device 113, an output device 114, and a communication interface 115. The electronic processor 111, the storage device 112, an input device 113, an output device 114, and a communication interface 115 communicate over one or more communication lines or buses, wireless connections, or a combination thereof. It should be understood that, in various configurations, the user device 110 may include additional or alternative components than those illustrated in FIG. 1 and may perform additional functions than the functionality described herein. For example, in some embodiments the user device 110 includes peripherals, for example, one or more output devices, for example, additional displays beyond output device 114, a speaker (not shown), or the like, and one or more input devices, for example, a keypad, a touchscreen, a microphone, a camera, or the like (not shown).

The electronic processor 111 may include one or more microprocessors, application-specific integrated circuit (ASIC), or other suitable electronic devices. The storage device 112 includes a non-transitory, computer readable medium. As used in the present application, non-transitory computer-readable medium comprises all computer-readable media except for a transitory, propagating signal. Accordingly, the storage device 112 may include, for example, a hard disk, an optical storage device, a magnetic storage device, ROM (read only memory), RAM (random access memory), register memory, a processor cache, or a combination thereof

The communication interface 115 sends data to external devices or networks, receives data from external devices or networks, or a combination thereof. The communication interface 115 may include a transceiver for wirelessly communicating over communication network 120 and, optionally, one or more additional communication networks or connections. Additionally or alternatively, in some embodiments, the communication interface 115 includes a port for receiving a wire or cable, for example, an Ethernet cable or Universal Serial Bus (USB) cable to facilitate a connection to an external device or network.

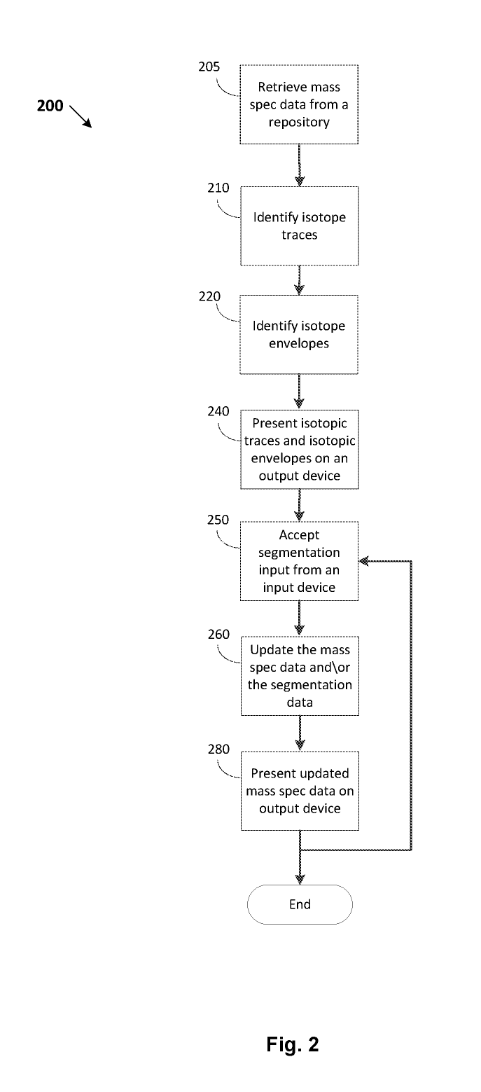

The electronic processor 111 is electrically connected to and executes instructions stored in the storage device 112. In particular, as illustrated in FIG. 1, the storage device 112 stores a segmentation data 116 storing data and information used by segmentation application software 117. The segmentation application software 117, interacting with operating system 118, accesses mass spec data 119 to identify and present isotopic traces and isotopic envelopes. As described in more detail in FIG. 2, the user device 110, through execution of the segmentation application software 117 by the electronic processor 111, identifies isotopic traces and isotopic envelopes and presents both isotopic traces and isotopic envelopes on the output device 114. When users interact with the presented isotopic traces and isotopic envelopes, the processor 111 may receive segmentation input from the input device 113 causing a change in the segmentation data 116.

In some embodiments, a server device 130, including a server processor 131, a storage device 132, an input device 133, an output device 134, and a communication interface 135 are included in system 100. A request from user device 110 may be communicated over communication network 120 to server device 130, causing server processor 131 to access the storage device 132 to retrieve all or part of mass spec data 136 stored on server 130, which is then communicated to user device 110 over communication network 120. It should be understood that mass spec data 119 and mass spec data 136 may store duplicate data, may store data but not be accessed by segmentation application software 117, or store parts of the totality of mass spec data, or some combination of these data placements without impacting or restricting the operation of the embodiment of system 100.

The system 100, shown in FIG. 1, may also include one or more user devices executing the segmentation application software 117, where the devices may be, for example, a personal computer, tablet computer, smart telephone, or similar device. It should be recognized that the segmentation data 116 and mass spec data 119 may be replicated and copies placed on a plurality of user devices 110 or server devices 130. In some embodiments, the segmentation application software 117 may execute on the server device 130 and be viewed on the user device 110 using output device 114. In still other embodiments, one or more users may access the segmentation data 116, segmentation application software 117, mass spec data 119 on the user device 110 communicating over the communication network 120.

FIG. 1 illustrates only one example embodiment of the system 100. The system 100 may include additional or fewer components in configurations different from the configuration illustrated in FIG. 1. For example, a plurality of storage devices, such as storage device 117 and storage device 132, may store all or portions of segmentation data 116 and mass spec data 119 and may be communicated to the segmentation application software 117, which may be on the user device 110 or server device 130. Also, in some embodiments, the functionality described here as being performed by the server device 130 may be distributed over multiple servers or other electronic devices.

FIG. 2 illustrates example method 200 for segmenting isotopic envelopes presented to a user on an output device according to one embodiment. The segmentation application software 117 communicating through communication interface 115 with server device 130 retrieves mass spectrometry data 136 from storage device 132 or from mass spectrometry data 119 on user device 110, or both (at block 205). The mass spectrometry data comprises isotopic trace points which may be measurements the mass-to-charge ratio of ions in tested matter. Such isotopic trace points are coupled to chromatographic techniques such as gas- or liquid chromatography which can be used to identify and characterize small molecules and proteins (proteomics). Mass spectrometry data typically contains a large number of isotopic trace points and requires that computers be used for data storage and processing. Determining which isotopic trace points should be placed in isotopic traces and which isotopic traces placed in which isotopic envelopes is difficult as many isotopic trace points can be placed in multiple isotopic traces, and many isotopic traces can potentially be placed in multiple isotopic envelopes, with the likelihood of erroneous placements at time high thus producing incorrect results.

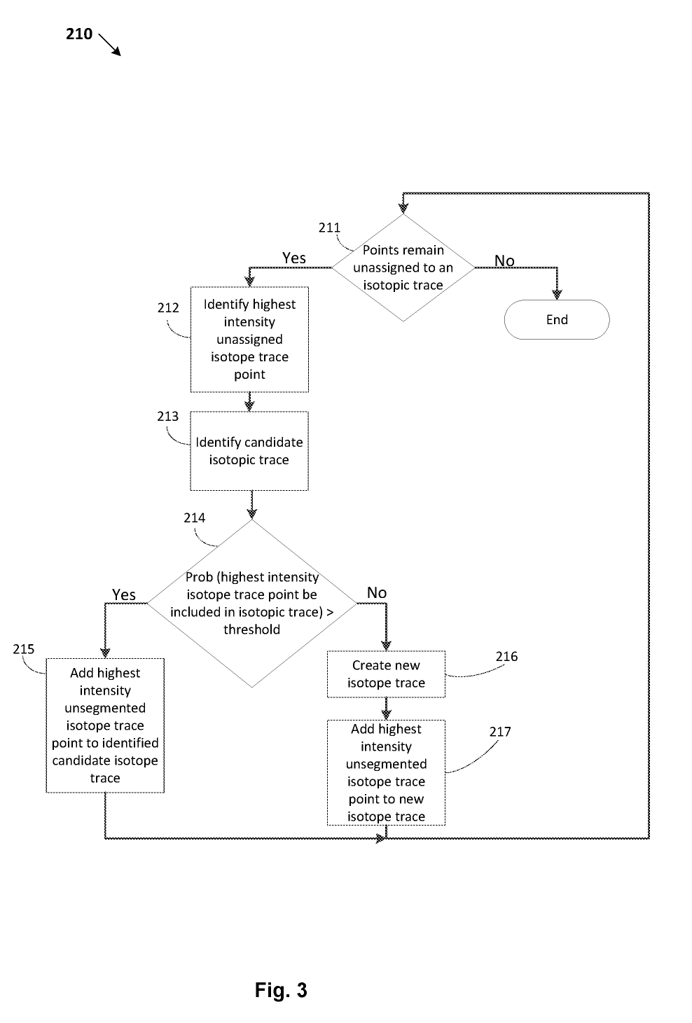

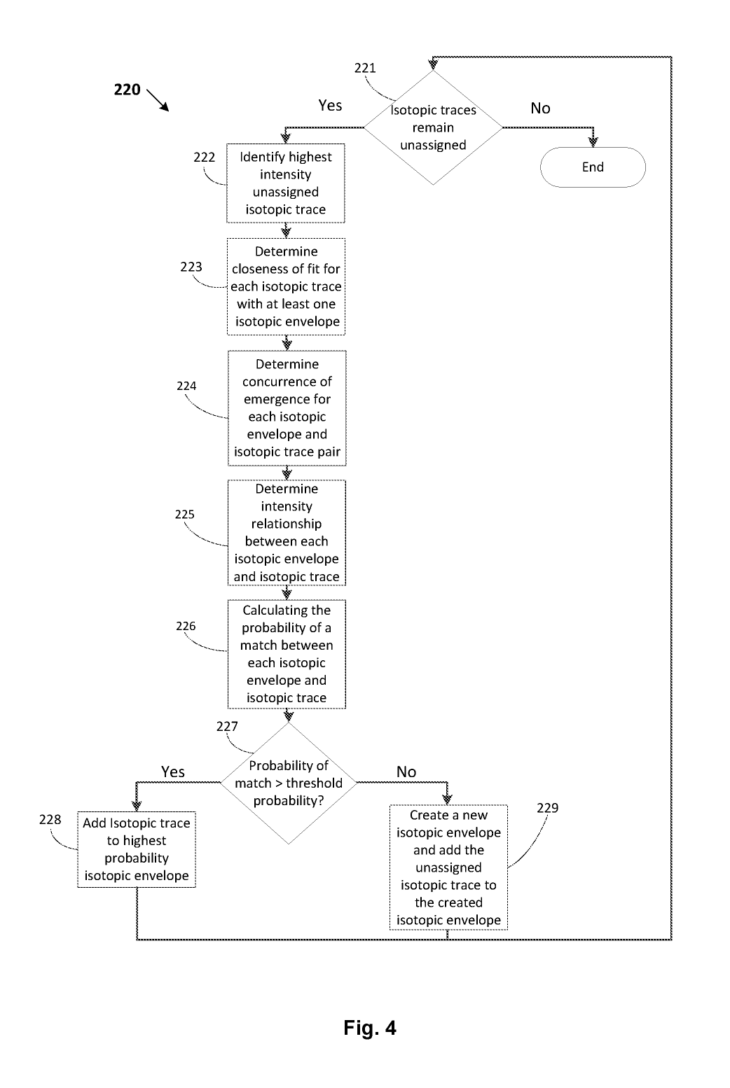

In example embodiment shown in FIG. 2, method 200 retrieves mass spectrometry data (at block 205). The mass spectrometry data retrieved by segmentation application software 117 (at block 205) is identified, in this example embodiment, as a plurality of isotopic traces (at block 210) and a plurality of isotopic envelopers (at block 220). The plurality of isotopic envelopes comprises a plurality of isotopic traces, and isotopic envelopes comprises a plurality of isotopic trace points. The segmentation application software 117, executing on electronic processor 111 in this example embodiment, identifies isotopic envelopes (at block 220) by placing isotopic trace points in isotopic traces, as described in further detail in FIG. 3, and placing isotopic traces into the most likely correct isotopic envelopes, as described in further detail in FIG. 4.

As shown in the example embodiment of FIG. 2, method 200 presents isotopic envelopes on output device 114 on user device 110 (at block 240). The segmentation application software 117 executing on electronic processor 111 presents isotopic envelopes as a plurality of isotopic trace points, a plurality of isotopic traces, and a plurality of isotopic envelopes in a graphical display on output device 114 wherein a user may review the plurality of isotopic trace points, isotopic traces, and isotopic envelopes. The segmentation application software accepts input from the user through input device 113 (at block 250) to segment the isotopic envelopes, isotopic traces, or isotopic trace points, or a combination of segmentation inputs. Segmentation input may include adding or removing isotopic trace points from isotopic traces, adding or removing isotopic traces from isotopic envelopes, or combining isotopic trace points into isotopic traces, combining isotopic traces into new isotopic envelopes, or a combination of these example segmentation inputs. While heuristic and mathematical methods may be used to determine isotopic traces and isotopic envelopes, many times users can visually determine more accurate isotopic envelopes and thus method 200 allows users provide segmentation input to manipulate mass spectrometry data.

The method 200 shown in the example embodiment of FIG. 2 updates the mass spectrometry data 119, the mass spectrometry data 136, or both, and the segmentation data 116 (at block 260). The segmentation application software 117, executing on electronic processor 111 in this example embodiment, uses segmentation input to update mass spectrometry data 119, mass spectrometry data 136, or both, and the segmentation data 116 in response to user input by adjusting the inclusion of isotopic trace points in isotopic traces, the inclusion of isotopic traces in isotopic envelopes, or both. The adjusted isotopic traces and isotopic envelopes are presented to the user on the output device 114 (at block 280). The user may continue to generate segmentation input from the input device, which is accepted by the segmentation application software 117 (at block 240) which updates mass spectrometry data 119, the mass spectrometry data 136, or both, and the segmentation data 116 (at block 260) and presented on the output device 114 (at block 280) until the user decides to stop providing segmentation input.

FIG. 3 shows an example method 210 for assigning isotopic points to isotopic traces. In this example embodiment, method 210 implemented by segmentation application software 117 executing on electronic processor 111 is applied when analyzing mass spectrometry data for display to a user, or after accepting user input (FIG. 2. at block 250), or both, but it should be understood that the example embodiment of method 210 could be used to assign isotopic trace points to isotopic traces prior to assigning a plurality of isotopic traces to isotopic envelopes. The segmentation application software 117 executing on electronic processor 111 may determine if any isotopic trace points remain unassigned to an isotopic trace (at decision block 211) and if unassigned isotopic trace points remain, identifies the highest intensity unsegmented isotopic trace point (at block 212). The most likely candidate isotopic trace for inclusion of the isotopic trace point is identified (at block 213) and if the probability that the highest intensity unsegmented point assignment be included in the most likely isotopic trace is greater than a user set threshold probability (at block 214), then the isotopic trace point is included in the highest probability isotopic trace (at block 215). Otherwise, the segmentation application software 117 executing on electronic processor 111 in this embodiment creates a new isotopic trace (at block 216) and adds the highest intensity unsegmented isotopic trace point to the new isotopic trace (at block 217) within the segmentation data 116. The segmentation application software 117 determines if isotopic trace points remain unassigned to isotopic traces (at block 211) and if so, the segmentation application software 117 identifies the highest intensity unsegmented isotopic trace point (at block 212) and proceeds as described previously. If not, method 210 terminates.

FIG. 4. shows further detail of an example embodiment of method 220 for assigning isotopic traces to isotopic envelopes. The segmentation application software 117 executing on electronic processor 111 calculates for a plurality of isotopic traces, a joint probability as a function of closeness, concurrence, and intensity relationship that an isotopic trace should be associated with at least one isotopic envelope. The isotopic trace with the highest probability of being assigned to an isotopic envelope, and the probability is greater than a threshold probability assigned set by the user, in this example embodiment, is assigned to the isotopic envelope. The segmentation application software 117 executing on electronic processor 111 determines if any isotopic traces remain unassigned to isotopic envelopes (at block 221) and if any isotopic traces remain unassigned calculates the intensity for the plurality of unassigned isotopic traces and identifies the highest intensity isotopic traces (at block 222). The segmentation application software 117 executing on electronic processor 111 determines the closeness of fit between the isotopic traces and at least one isotopic envelope (at block 223) using the mass number and the charge number (M/Z) distance of (1/n), where n is any whole integer. The segmentation application software 117 executing on electronic processor 111 determines the concurrence of emergence for the plurality of isotopic traces and at least one isotopic envelope (at block 224). The intensity relationship between the plurality of isotopic traces and at least one isotopic envelope is determined by segmentation application software 117 executing on electronic processor 111 (at block 225). In order to assign isotopic traces to isotopic envelopes, in this example embodiment, segmentation application software 117 executing on electronic processor 111 calculates the probability of a match between the plurality of isotopic traces and at least on isotopic envelope (at block 226) using the intensity, closeness of fit, concurrence, and intensity relationship. In this example embodiment, the segmentation application software 117 executing on electronic processor 111 determines if unassigned isotopic trace with the highest probability of being included in an isotopic envelope exceeds a user specified threshold probability (at block 227) and if so, assigns the unassigned isotopic trace to the associated isotopic envelope (at block 228). If the unassigned isotopic trace with the highest probability of being included in an isotopic envelope does not exceed the user specified threshold probability (at block 227) the segmentation application software 117 executing on electronic processor 111 assigns the unassigned isotopic trace to a new isotopic trace (at block 229). The segmentation application software 117 executing on electronic processor 111 determines if any unassigned isotopic traces remain, and if not, the assignment of isotopic traces to isotopic envelopes ends.

It should be recognized that in other, alternative embodiments, the segmentation application software 117 could execute on an application server, web server, or other computing device, without altering the functionality described here. In addition, the mass spec data, segmentation data, or both, could be located on a file server, web server, external storage device, or the like, again without altering the functionality of the segmentation application server 117 as described in this embodiment.

Various features and advantages of some embodiments are set forth in the following claims.

What is claimed is:

1. A system for segmenting mass spectrometry data, the system comprising:
at least one electronic processor configured to
retrieve a plurality of isotopic trace points from mass spectrometry data stored in an electronic repository;
identify a plurality of isotopic traces, wherein at least one of the plurality of isotopic traces comprises a subset of the plurality of isotopic trace points stored as mass spectrometry data;
identify a plurality of isotopic envelopes, wherein at least one of the plurality of isotopic envelopes comprises a subset of the plurality of isotopic traces, where the isotopic traces are stored as segmentation data;
present, on an output device, the mass spectrometry data as the plurality of isotopic envelopes and the plurality of isotopic traces;
accept input segmenting the graphic display of mass spectrometry data;
update the mass spectrometry data and the segmentation data using the input segmenting the mass spectrometry data; and
present, on the output device, an updated graphic display of the mass spectrometry data based on the input segmenting the mass spectrometry data.

2. The system of claim 1 wherein the at least one electronic processor is further configured to present on an output device the mass spectrometry data graphically as a plurality of isotopic envelopes, a plurality of isotopic traces, and a plurality of isotopic trace points in a three-dimensional graph wherein the graphic display is a three-dimensional graph with an axis for intensity, an axis for mass-to-charge ratio (M/Z), and an axis for retention time.

3. The system of claim 1 wherein the at least one electronic processor is further configured to accept input from an input device segmenting the plurality of isotopic trace points wherein the segmenting input is selected from a group consisting of identifying a subset of the plurality of isotopic trace points for storage in a repository, adding a trace point to an isotopic trace, removing points from an isotopic trace, creating a new isotopic trace, and deleting an isotopic trace.

4. The system of claim 1 wherein the at least one electronic processor is further configured to accept input segmenting the graphic display of mass spectrometry data wherein the segmenting input is selected from a group consisting of identifying a subset of the plurality of isotopic envelopes for storage, adding isotopic traces to an isotopic envelope, removing isotopic traces from an isotopic envelope, creating a new isotopic envelope, and deleting an isotopic envelope.

5. The system of claim 1 wherein the at least one electronic processor is further configured to accept input causing mass spectrometry data to be displayed that has not yet been segmented.

6. A method for segmenting mass spectrometry data, the method comprising:
retrieving, with an electronic processor, a plurality of isotopic trace points stored as mass spectrometry data in an electronic repository;
identifying, with an electronic processor, a plurality of isotopic traces, wherein the plurality of isotopic traces comprises a subset of the plurality of isotopic trace points stored as mass spectrometry data;
identifying, with an electronic processor, a plurality of isotopic envelopes, wherein the plurality of isotopic envelopes comprises a plurality of isotopic traces;
presenting, on an output device, the plurality of isotopic envelopes, wherein the plurality of isotopic envelopes comprises at least one of the plurality of isotopic traces,
accepting input from an input device segmenting the graphic display of mass spectrometry data,
updating the mass spectrometry data and the segmentation data using the input segmenting the mass spectrometry data, and
presenting, on the output device, an updated graphic display of the mass spectrometry data based on the input segmenting the mass spectrometry data.

7. The method of claim 6 wherein identifying isotopic envelopes includes:
identifying, with an electronic processor, the highest intensity unassigned isotopic trace from the plurality of isotopic traces;
determining, with an electronic processor, the closeness of fit for the plurality of isotopic traces with the at least one isotopic envelope as the M/Z and distance of (1/n), where n is any whole integer;
determining, with an electronic processor, the concurrence of emergence of the plurality of isotopic traces paired with the at least one isotopic envelope by analyzing isotopic trace onset, apex, and attenuation;
determining, with an electronic processor, the intensity relationship between the plurality of isotopic traces and the at least one isotopic envelope;
calculating, with an electronic processor, the probability of a match between the plurality of isotopic traces and the at least one isotopic envelope;
if highest probability match between an unassigned isotopic trace and an isotopic envelope exceeds the threshold probability, add the unassigned isotopic trace to the isotopic envelope, otherwise create a new isotopic envelope and add the unassigned isotopic trace to the new isotopic envelope; and
if none of the plurality of isotopic traces remain unassigned to isotopic envelopes then end identifying isotopic envelopes, otherwise continue identifying isotopic envelopes.

8. The method of claim 6 wherein identifying, with an electronic processor, a plurality of isotopic traces includes:
identifying, with an electronic processor, from a plurality of unsegmented isotopic trace points in mass spectrometry data, the highest intensity unsegmented isotopic trace point in the mass spectrometry data, where the unsegmented isotopic trace point has not been assigned to an isotopic trace;
identifying a candidate isotopic trace to include the highest intensity unsegmented isotopic trace point in the mass spectrometry data; and
determining if the probability the highest intensity unsegmented isotopic trace point should be included in the candidate isotopic trace is greater than a threshold probability value and if so, adding the highest intensity unsegmented isotopic trace point to the candidate isotopic trace, otherwise creating a new isotopic trace that includes the highest intensity unsegmented isotopic trace point.

9. The method of claim 8, wherein the threshold probability value is greater than 50%.

10. The method of claim 8, wherein identifying, with an electronic processor, from a plurality of unsegmented isotopic trace points in mass spectrometry data the highest intensity unsegmented isotopic trace point in the mass spectrometry includes comparing the intensity of unsegmented isotopic trace points using M/Z measurements.
